(19) United States
(12) Patent Application Publication
(10) Pub. No.: US 2011/0184096 A1
(43) Pub. Date: Jul. 28, 2011

(54) COATED PIGMENT COMPOSITION

(76) Inventors: Sivapackia Ganapathiappan, Los Altos, CA (US); Hou T. Ng, Palo alto, CA (US); Howard S. Tom, San Jose, CA (US)

(21) Appl. No.: 12/693,326

(22) Filed: Jan. 25, 2010

(51) Int. Cl. C08K 5/3432; B05D 7/00; C08K 3/22

(52) U.S. Cl. 524/88; 427/214; 524/430

(57) ABSTRACT

A polymer-coated pigment composition includes at least one organic pigment and a coating layer non-covalently attached to an outer surface of the organic pigment. The coating layer comprises at least one metal oxide or the metalloid oxide and a polymer attached to an outer surface of the metal oxide or metalloid oxide. A method of enhancing dispersibility of an organic pigment includes coating a surface of the organic pigment with the metal oxide or the metalloid oxide, or a combination thereof, and attaching the polymer to the metal oxide or the metalloid oxide, or the combination. An ink composition includes an ink vehicle and the polymer-coated pigment composition described above.

### CROSS-REFERENCE TO RELATED APPLICATIONS

N/A

### STATEMENT REGARDING FEDERALLY SPONSORED RESEARCH OR DEVELOPMENT

N/A

### BACKGROUND

Inkjet printers are now very common and affordable and allow one to obtain decent print quality. They are used in home printing, office printing and commercial printing. The growth of inkjet printing is the result of a number of factors including reductions in cost of inkjet printers and improvements in print resolution and overall print quality. A continued demand in inkjet printing has resulted in the need to produce images of high quality, high permanence and high durability while maintaining a reasonable cost.

One of the major factors contributing to the cost of printing in general is the cost of pigments that are employed in printing inks. Colored pigments such as yellow and magenta are relatively costly compared to cyan and black colored pigments. Although lower cost pigments might be employed for various printing applications, performance is generally poor with respect to dispersion stability, light fastness and printability, for example. One of the factors that contribute to poor performance is the extensive amount of impurities in these pigments. For example, yellow pigment 74 (PY74) is one of the lowest cost pigments compared to other high performance yellow pigments. However, PY74 has, among other things, poor stability to light exposure and poor light fastness. Furthermore, PY74 is difficult to formulate into a stable ink dispersion. The presence of impurities in low cost pigments also affects the ability to attach a polymer to the pigment.

### DETAILED DESCRIPTION

Some embodiments of the present invention are directed to a polymer-coated pigment composition comprising at least one organic pigment, and a coating layer non-covalently attached to an outer surface of the organic pigment. The coating layer comprises at least one metal oxide or metalloid oxide and a polymer attached to an outer surface of the metal oxide or metalloid oxide. Some embodiments of the present invention are directed to an ink composition comprising an ink vehicle and the polymer-coated pigment composition described above.

Some embodiments of the present invention are directed to a method of enhancing dispersibility of an organic pigment. A surface of the organic pigment is coated by non-covalently attaching to the surface a metal oxide or a metalloid oxide or a combination thereof followed by attaching a polymer to the metal oxide or metalloid oxide. In some embodiments, the coating is carried out by contacting a surface of the pigment with a metal oxide or a metal oxide precursor or a metalloid oxide or a metalloid oxide precursor under conditions wherein the metal oxide or metalloid oxide becomes non-covalently attached to the surface of the pigment. In some embodiments, the coating is carried out by a type of sol-gel process.

Some embodiments of the present invention are directed to an ink composition comprising an ink vehicle and a polymer-coated pigment composition comprising at least one organic pigment and a coating layer comprising silicon oxide non-covalently attached to an outer surface of the organic pigment and a latex polymer attached to an outer surface of the silicon oxide.

A polymer-coated pigment composition in accordance with present embodiments comprises at least one organic pigment or at least two organic pigments or at least three organic pigments, for example. The number of organic pigments in the pigment composition is in the range of 1 to about 5, or about 1 to about 4, or about 1 to about 3, or 1 to 2, or 2 to about 5, or 2 to about 4, or 2 to 3, for example. A pigment is a substance that changes the color of light that the substance reflects as the result of selective color absorption. The pigment may or may not impart a color. The organic pigment may be a naturally-occurring pigment or a synthetic pigment. The organic pigment can be of any color including, but not limited to, black, blue, brown, cyan, green, white, violet, magenta, red, orange and yellow, as well as spot colors from mixtures thereof. For electro-photographic printing important colors include Cyan (C), Magenta (M), Yellow (Y), and Black (K), which are precisely layered to create thousands of other colors. The pigment composition can include black pigment-based inks and colored pigment-based inks (e.g., blue, brown, cyan, green, white, violet, magenta, red, orange, yellow, as well as mixtures thereof). The pigment composition may include other materials such as, for example, one or more of ceramics, extender pigments (e.g., silicas, clays, alkaline earth metal sulfates such as calcium sulfate and barium sulfate), stabilizers (e.g., surfactants and polymeric dispersants), and corrosion inhibitor pigments (e.g., aluminum phosphate and calcium modified silica).

Examples of organic pigments that may be treated in accordance with the present embodiments include, by way of illustration and not limitation, perylenes, phthalocyanine pigments (for example, phthalo green, phthalo blue), cyanine pigments (Cy3, Cy5, and Cy7), naphthalocyanine pigments, nitroso pigments, monoazo pigments, diazo pigments, diazo condensation pigments, basic dye pigments, alkali blue pigments, blue lake pigments, phloxin pigments, quinacridone pigments, lake pigments of acid yellow 1 and 3, isoindolinone pigments, dioxazine pigments, carbazole dioxazine violet pigments, alizarine lake pigments, vat pigments, phthaloxy amine pigments, carmine lake pigments, tetrachloroisoindolinone pigments, perinone pigments, thioindigo pigments, anthraquinone pigments and quinophthalone pigments, and mixtures of two or more of the above and derivatives of the above.

By way of illustration and not limitation, representative examples of phthalocyanine blues include copper phthalocyanine blue and derivatives thereof (Pigment Blue 15). Representative examples of quinacridones include Pigment Orange 48, Pigment Orange 49, Pigment Red 122, Pigment Red 192, Pigment Red 202, Pigment Red 206, Pigment Red 207, Pigment Red 209, Pigment Violet 19 and Pigment Violet 42. Representative examples of anthraquinones include Pigment Red 43, Pigment Red 194 (Perinone Red), Pigment Red 216 (Brominated Pyanthrone Red) and Pigment Red 226 (Pyranthrone Red). Representative examples of perylenes include Pigment Red 123 (Vermillion), Pigment Red 149 (Scarlet), Pigment Red 179 (Maroon), Pigment Red 190 (Red), Pigment Red 189 (Yellow Shade Red) and Pigment Red 224. Representative examples of thioindigoids include Pigment Red 86, Pigment Red 87, Pigment Red 88, Pigment Red 181, Pigment Red 198, Pigment Violet 36, and Pigment Violet 38. Representative examples of heterocyclic yellows include Pigment Yellow 1, Pigment Yellow 3, Pigment Yellow 12, Pigment Yellow 13, Pigment Yellow 14, Pigment Yellow 17, Pigment Yellow 65, Pigment Yellow 73, Pigment Yellow 74, Pigment Yellow 151, Pigment Yellow 117, Pigment Yellow 128, and Pigment Yellow 138. Other examples of pigments include those of the HOSTAFINE® series (trademark of Clariant GmbH, Frankfurt, Germany), the PALIOGEN® series and the HELIOGEN® series (both trademarks of BASF Aktiengesellschaft, Ludwigshafen, Germany), the SUDAN® series, the HOSTPERM® series and the HEUCO® series (trademark of Heubach GmbH, Langelsheim, Germany), for example.

The organic pigment is particulate in some embodiments. The shape of a particulate pigment may be regular or irregular. The particulate pigment may be in the form of a bead, flake, plate, rod, platelet, cube and column, for example. In some embodiments the cross-sectional shape of the particulate pigment may be circular, triangular, square, quadrangular, hexangular, oval, scalloped, corrugated, or ellipsoidal, for example.

The particle size (cross-sectional dimension) of the particulate pigment is in a range from about 1 nanometer (nm) to about 500 nm, or from about 1 nm to about 400 nm, or from about 1 nm to about 300 nm, or from about 1 nm to about 200 nm, or from about 1 nm to about 100 nm, or from about 1 nm to about 50 nm, or from about 5 nm to about 500 nm, or from about 5 nm to about 400 nm, or from about 5 nm to about 300 nm, or from about 5 nm to about 200 nm, or from about 5 nm to about 100 nm, or from about 5 nm to about 50 nm, or from about 10 nm to about 500 nm, or from about 10 nm to about 400 nm, or from about 10 nm to about 300 nm, or from about 10 nm to about 200 nm, or from about 10 nm to about 100 nm, or from about 10 nm to about 50 nm.

As mentioned above, the coating layer comprises a metal oxide or a metalloid oxide or a combination of two or more metal oxides, or two or more metalloid oxides or one or more metal oxides and one or more metalloid oxides. Metal oxides include, for example, aluminum oxide, zinc oxide, germanium oxide, tin oxide, indium oxide, magnesium oxide, titanium oxide, manganese oxide, iron oxide, zirconium oxide, niobium oxide, yttrium oxide and scandium oxide and combinations and derivatives thereof. Metalloid oxides include, for example, silica (silicon oxide).

The metal oxides or metalloid oxides either contain a sufficient number of hydroxyl groups to provide for coupling of molecules of the metal oxide or metalloid oxide together to form an interlinked layer of metal oxide or metalloid oxide and for non-covalently attaching the coating layer to the surface of an organic pigment. Hydroxyl groups may be introduced onto the surface of the metal oxide or metalloid oxide by methods known in the art such as, for example, plasma treatment, acidification techniques and oxidation techniques.

The term “silicon oxide” or “silica” includes the various molecular forms of silicon oxide, for example, silicon monoxide, silicon dioxide, silicon tetraoxide, and polymers (for example, dimers, trimers, tetramers and pentamers) thereof. In some embodiments the silicon oxide is silicon dioxide in the form of fumed silica or silica gel. These latter substances are hygroscopic and take on water thereby introducing hydroxyl groups onto the surface of the silicon dioxide. The relatively high surface area of fumed silica particles and silica gel particles facilitates the absorption of water, which introduces sufficient number of hydroxyl groups for the interaction of hydroxyl groups among molecules of the metal oxide or metalloid oxide.

In some embodiments the thickness of the coating layer is about 1 nm to about 100 nm, or about 1 nm to about 75 nm, or about 1 nm to about 50 nm, or about 1 nm to about 40 nm, or about 1 nm to about 30 nm, or about 1 nm to about 20 nm, or about 1 nm to about 10 nm, or about 5 nm to about 100 nm, or about 5 nm to about 75 nm, or about 5 nm to about 50 nm, or about 5 nm to about 40 nm, or about 5 nm to about 30 nm, or about 5 nm to about 25 nm, or about 5 nm to about 20 nm, for example.

The non-covalent attachment of the metal oxide or metalloid oxide layer to the pigment usually results from physical forces of attraction or intermolecular forces such as, for example, one or more of hydrogen bonding, van der Waals forces (e.g., one or more of dipole-dipole interactions, dipole-induced-dipole interactions, attraction between non-polar molecules such as London forces and hydrophobic interactions), electrostatic forces, and ion-ion molecular forces. For hydrogen bonding, hydrogen is usually covalently bonded to an electronegative atom such as, for example, an oxygen atom, a nitrogen atom, or a fluorine atom and hydrogen bonding occurs between such a hydrogen and another electronegative atom.

Alternatively, hydroxyl groups may be present on the surface of the particulate pigment or hydroxyl groups may be introduced on the surface of the particulate pigment. Introduction of hydroxyl groups may be carried out by one or more of the methods discussed above. Hydroxyl groups on the organic pigment may bond, by means of hydrogen bonding, with an oxide oxygen of a hydroxyl group of a metal oxide interface layer or a metalloid oxide coating layer.

In some embodiments a type of sol/gel process is employed to provide a coating layer of metal oxide or metalloid oxide on a particulate organic pigment. In some embodiments of the sol/gel process employed in preparing a coated organic pigment, an organic pigment and a metal alkoxide or a metalloid alkoxide are dispersed in an aqueous medium. The alkoxide of the metal or metalloid may be an alkyl group bound to a metal or metalloid through an ether linkage. The alkyl may have 1 to about 10 carbon atoms, or 1 to about 9 carbon atoms, or 1 to about 8 carbon atoms, or 1 to about 7 carbon atoms, or 1 to about 6 carbon atoms, or 1 to about 5 carbon atoms, or 1 to about 4 carbon atoms, or 1 to about 3 carbon atoms, or 1 to 2 carbon atoms, or 2 to about 10 carbon atoms, or 2 to about 5 carbon atoms, or 2 to about 4 carbon atoms, or 2 to 3 carbon atoms, for example. The alkyl group may be, for example, methyl, ethyl, n-propyl, isopropyl, n-butyl, isobutyl or t-butyl. The number of alkyl groups on the metal or metalloid atom depends on the nature of the metal or metalloid, for example. In some embodiments the number of alkyl groups on the metal or metalloid may be 1 to about 4, or 1 to about 3, or 1 to 2, or 2 to about 4, or 2 to 3, or 3 to 4, for example. Examples of metal alkoxide and metalloid alkoxides that may be employed in the sol/gel process include by way of illustration and not limitation, tetraethyl orthosilicate, tetramethyl orthosilicate, propoxytriethoxysilane, diethoxydimethoxysilane, tetraacetoxysilane, titanium (IV) methoxide, titanium (IV) ethoxide.

Metal alkoxides and metalloid alkoxides are commercially available or may be synthesized by, for example, reacting an alkyl group having a substituent (leaving group) that is displaceable by reaction with a hydroxyl group or hydroxide group of the metal or metalloid. The alkyl group may include a substituent such as, for example, halide, sulfate, aryl sulfate, triflate and acetates. The reaction may be carried out in an aqueous medium in the presence of a suitable base such as, for example, a metal hydroxide (sodium hydroxide or potassium hydroxide, for example) or ammonia.

The aqueous medium for the sol/gel process may be solely water or may contain other solvents such as organic solvents. For example, the aqueous medium may contain organic solvents such as alcohols, ethers, esters, amides, glycols, or pyrrolidones, or mixtures of two or more organic solvents. The amount (by weight percent) of the organic solvent in the water may be between about 0.01 and about 25%, or between about 0.01 and about 20%, or between about 0.01 and about 10% or between about 0.01 and about 5%, or about 0.1 and about 20%, or between about 0.1 and about 10% or between about 0.1 and about 5%, or about 1 and about 20%, or between about 1 and about 10% or between about 1 and about 5%. The aqueous medium may also optionally include one or more water-soluble surfactants in amounts ranging between about 0 and 5%, or between about 0.1 and about 5%, or about 0.5 and about 5%, or about 1 to about 5%. Examples of suitable surfactants include, by way of illustration and not limitation, fluorosurfactants, alkyl polyethylene oxides, non-ionic surfactants, amphoteric surfactants, ionic surfactants, and mixtures of two or more of the above. The aqueous medium may also include a basic catalyst such as, for example, ammonia.

The mixture is heated at a temperature of about 5° C. to about 99° C., or from about 15° C. to about 70° C., or from about 20° C. to about 45° C., or from about 20° C. to about 30° C., or about ambient temperature, for example, for a period of about 1 second to about 60 minutes, or about 1 second to about 30 minutes, or about 1 second to about 15 minutes, or about 1 second to about 10 minutes, or about 1 second to about 5 minutes, or about 1 second to about 1 minute, for example. The pH of the aqueous mixture is in the range of about 1 to about 10, or about 3 to about 9, or about 5 to about 8, for example.

The aforementioned processes yield an organic pigment that has a coating of a metal oxide or metalloid oxide wherein the metal oxide or metalloid oxide molecules are covalently bound to one another on the surface of the organic pigment to provide an interlinked coating and wherein the metal oxide or metalloid oxide coating is non-covalently attached to the surface of the organic pigment. Different metal oxide or metalloid oxide compounds can be used to adjust the hydrophobicity and hydrophilicity of the organic pigment of the composition.

As mentioned above, the coating of the polymer-coated pigment composition also comprises a polymer attached to the outer surface of the metal oxide or the metalloid oxide. In some embodiments, the polymer is about 5 to about 10,000 monomer units or more in length, or about 10 to about 10,000 monomer units in length, or about 100 to about 10,000 monomer units in length, or about 500 to about 10,000 monomer units in length, or about 1,000 to about 10,000 monomer units in length, or about 2,000 to about 10,000 monomer units in length, or about 3,000 to about 10,000 monomer units in length, or about 5,000 to about 10,000 monomer units in length, or about 10 to about 8,000 monomer units in length, or about 100 to about 8,000 monomer units in length, or about 1,000 to about 8,000 monomer units in length, or about 100 to about 7,000 monomer units in length, for example. The term “monomer” means a molecule capable of undergoing polymerization to form a polymer. The number of monomer units depends on the number of atoms in the monomer unit chain, and the composition of the monomer unit, for example.

In some embodiments the molecular weight of the polymer is about 500 to about 10,000,000 amu or more, or about 700 to about 10,00,000 amu, or about 1,000 to about 10,000,000 amu, or about 10,000 to about 10,000,000 amu, or about 100,000 to about 10,000,000 amu, or 300 to about 5,000,000 amu or more, or about 500 to about 5,00,000 amu, or about 1,000 to about 5,000,000 amu, or about 10,000 to about 5,000,000 amu, or about 100,000 to about 5,000,000 amu, or 500 to about 1,000,000 amu or more, or about 700 to about 1,00,000 amu, or about 1,000 to about 1,000,000 amu, or about 10,000 to about 1,000,000 amu, or about 100,000 to about 1,000,000 amu, or about 500 to about 750,000 amu, or about 500 to about 750,000 amu, or about 1,000 to about 750,000 amu, or about 10,000 to about 750,000 amu, or about 100,000 to about 750,000 amu, or about 500 to about 500,000 amu, or about 700 to about 500,000 amu, or about 1,000 to about 500,000 amu, or about 10,000 to about 500,000 amu, or about 100,000 to about 500,000 amu, for example. In some embodiments, the monomer units of the polymer comprise carbon atoms and may additionally comprise one or more heteroatoms such as, for example, oxygen, sulfur, nitrogen, phosphorus and silicon.

The polymer may be a linear polymer or a branched polymer or a combination thereof. A linear polymer comprises a linear chain of atoms and a branched polymer comprises a branched chain of atoms. Each atom of the linear chain may have one or more substituents in place of hydrogen. In some embodiments, the polymer may be a copolymer comprising more than one type of monomer unit. The relationship of the different monomer units in the polymer may be alternating, random or periodic, for example, and the polymer may also be in a block copolymer arrangement where blocks of repeating monomer units form the polymer chain.

In some embodiments the polymer is non-covalently attached to an outer surface of the metal oxide or metalloid oxide coating the pigment. Non-covalent attachment may be by means of coating or encapsulation, for example. In some embodiments the polymer is covalently attached to an outer surface of the metal oxide or metalloid oxide coating the pigment. In the latter embodiments the polymer may be preformed and covalently linked to a surface of the metal oxide coating of the organic pigment or to a surface of the metalloid oxide coating of the organic pigment. In other embodiments, the polymer may become covalently attached to a surface of the metal oxide coating of the organic pigment or to a surface of the metalloid oxide coating of the organic pigment during the polymerization of one or more monomers. The preparation of polymer of the polymer-coated pigment compositions depends on the type of attachment of the polymer to a surface of the metal oxide coating or metalloid oxide coating that is non-covalently attached to an outer surface of the organic pigment.

In some embodiments the polymer coating may be prepared from one or more monomers in a number of approaches known in the art. Examples of approaches for preparing polymers that are non-covalently attached to a surface of the metal oxide coating or metalloid oxide coating, by way of illustration and not limitation, include emulsification or emulsion polymerization, free radical polymerization, redox polymerization, bulk polymerization, transition metal catalyzed coupling, condensation (step reaction) polymerization, living polymerization, living radical polymerization, addition (chain reaction) polymerization (anionic, etc.), coordination polymerization, emulsion polymerization, ring opening polymerization, solution polymerization, step-growth polymerization, plasma polymerization, Ziegler process, radical polymerization, atom transfer radical polymerization, and nitroxide mediated polymerization, for example. Examples of approaches for preparing polymers that are covalently attached to a surface of the metal oxide coating or metalloid oxide coating, by way of illustration and not limitation, include reversible addition fragmentation-chain transfer polymerization, for example. The conditions employed for the polymerization depend on one or more of the particular polymerization or other method employed and the nature of the monomers, for example.

Methods of encapsulating the organic pigment having a metal oxide or metalloid oxide coating include, for example, mini-emulsion polymerization, inversion emulsification, inverse-emulsion polymerization, for example. The conditions employed for polymer encapsulation of the metal oxide coated organic pigment or metalloid oxide coated organic pigment depend on one or more of the particular polymerization or other method of encapsulation employed and the nature of the monomers, for example.

In some embodiments the polymer is a latex polymer. The latex polymer may be derived from a number of monomers such as, by way of example and not limitation, vinyl monomers, allylic monomers, olefins, and unsaturated hydrocarbons, and mixtures thereof. Classes of vinyl monomers include, but are not limited to, acrylic acid, acrylates, acrylamides, methacrylic acid, methacrylates, methacrylamide, N- and N,N-disubstituted methacrylamides, vinyl aromatic monomers, vinyl halides, vinyl esters of carboxylic acids (e.g., vinyl acetate), and vinyl ethers. The monomers may further be classified as acidic (acrylic acid, methacrylic acid, itaconic acid, maleic acid, vinyl benzoic acids, and styrene sulfonates, for example) and hydrophobic (acrylates, methacrylates, styrene and substituted styrene, for example).

Examples of methacrylates include, but are not limited to, methyl methacrylate, ethyl methacrylate, propyl methacrylate, isopropyl methacrylate, n-butyl methacrylate, iso-butyl methacrylate, tert-butyl methacrylate, hexyl methacrylate, 2-ethylhexyl methacrylate, lauryl methacrylate, octadecyl methacrylate, isobornyl methacrylate, cyclohexyl methacrylate, benzyl methacrylate, 3,3,5-trimethylcyclohexyl methacrylate, isocane methacrylate, glycidyl methacrylate, 3,4-epoxycyclohexylmethyl-methacrylate, 2-(3,4-epoxycyclohexyl)ethyl-methacrylate, hydroxyethyl methacrylate, hydroxypropyl methacrylate, hydroxybutyl methacrylate, methacrylic anhydride, diethyleneglycol bismethacrylate, 4,4′-isopropylidenediphenol bismethacrylate (Bisphenol A dimethacrylate), alkoxylated 4,4′-isopropylidenediphenol bismethacrylate, trimethylolpropane trismethacrylate and alkoxylated trimethylolpropane trismethacrylate.

Examples of vinyl aromatic monomers that may be used include, but are not limited to, styrene, 3-methylstyrene, 4-methylstyrene, styrene-butadiene, p-chloro-methylstyrene, 2-chlorostyrene, 3-chlorostyrene, 4-chlorostyrene, divinyl benzene, vinyl naphthalene and divinyl naphthalene. Vinyl halides that may be used include, but are not limited to, vinyl chloride and vinylidene fluoride. Vinyl esters of carboxylic acids that may be used include, but are not limited to, vinyl acetate, vinyl butyrate, vinyl methacrylate, vinyl 3,4-dimethoxybenzoate, vinyl malate and vinyl benzoate. Examples of vinyl ethers that may be employed include, but are not limited to, butyl vinyl ether and propyl vinyl ether, for example.

In some embodiments a mixture of one or more hydrophobic monomers and one or more acid monomers may be employed. The number of different monomers employed may be, for example, 1 to about 10, or about 1 to about 9, or about 1 to about 8, or about 1 to about 7, or about 1 to about 6, or about 1 to about 5, or about 1 to about 4, or about 1 to about 3, or 1 to 2, or 2 to about 10, or about 2 to about 9, or about 2 to about 8, or about 2 to about 7, or about 2 to about 6, or about 2 to about 5, or about 2 to about 4, or 2 to 3, or 3 to about 10, or about 3 to about 9, or about 3 to about 8, or about 3 to about 7, or about 3 to about 6, or about 3 to about 5, or 3 to 4.

One or both of the amount of each type of monomer in the mixture and the amount of each hydrophobic monomer or each acid monomer is dependent on the desired character of the coated pigment and the nature of the metal oxide or metalloid oxide coating, for example. In some embodiments the number, type and amount of monomers are chosen to adjust the glass transition temperature (T_{g}) of the polymer. In some embodiments the T_{g} of the polymer is about −100° C. to about +150° C., or about −50° C. to about +150° C., or about −40° C. to about +150° C., or about −40° C. to about +120° C., or about −40° C. to about +100° C., or about −40° C. to about +80° C., or 0° C. to about +150° C., or 0° C. to about +120° C., or 0° C. to about +100° C., or 0° C. to about +75° C., or 0° C. to about +50° C., or −25° C. to about +100° C., or about −25° C. to about +75° C., or about −25° C. to about +50° C., or -25° C. to about +25° C., for example.

In some embodiments a crosslinking monomer can be used in the preparation of the polymer-coated pigment composition. The crosslinking monomer is a compound having two or more of unsaturated hydrocarbon groups of at least one kind selected from the group consisting of a vinyl group, an allyl group, an acryloyl group, a methacryloyl group, a propenyl group, a vinylidene group and a vinylene group. Examples thereof include ethylene glycol diacrylate, diethylene glycol diacrylate, triethylene glycol diacrylate, tetraethylene glycol diacrylate, polyethylene glycol diacrylate, allyl acrylate, bis(acryloxyethyl)hydroxyethyl isocyanurate, bis(acryloxyneopentyl glycol) adipate, 1,3-butylene glycol diacrylate, 1,6-hexanediol diacrylate, neopentyl glycol diacrylate, propylene glycol diacrylate, polypropylene glycol diacrylate, 2-hydroxy-1,3-diacryloxypropane, 2,2-bis[4-(acryloxy)phenyl]propane, 2,2-bis[4-(acryloxyethoxy)-phenyl]propane, 2,2-bis[4-(acryloxyethoxydiethoxy)-phenyl]propane, 2,2-bis[4-(acryloxyethoxypoly-ethoxy)phenyl]propane, hydroxypivaric acid neopentyl glycol diacrylate, 1,4-butanediol diacrylate, dicyclopentanyl diacrylate, dipentaerythritol hexaacrylate, dipentaerythritol monohydroxypentaacrylate, ditrimethylolpropane tetraacrylate, pentaerythritol triacrylate, tetrabromobisphenol A diacrylate, triglycerol diacrylate, trimethylolpropane triacrylate, tris(acryloxyethyl) isocyanurate, ethylene glycol dimethacrylate, diethylene glycol dimethacrylate, triethylene glycol dimethacrylate, tetraethylene glycol dimethacrylate, polyethylene glycol dimethacrylate, propylene glycol di-methacrylate, polypropylene glycol dimethacrylate, 1,3-butylene glycol dimethacrylate, 1,4-butanediol dimethacrylate, 1,6-hexanediol dimethacrylate, neopentyl glycol dimethacrylate, 2-hydroxy-1,3-di-methacryloxypropane, 2,2-bis[4-(methacryloxy)phenyl]propane, 2,2-bis[4-(methacryl-oxyethoxy)phenyl]propane, 2,2-bis[4-(methacryloxythioxydiethoxy)-phenyl]propane, 2,2-bis[4-(methacryloxy-ethoxypolyethoxy)phenyl]propane, tetrabromobisphenol A dimethacrylate, dicyclopentanyl dimethacrylate, dipentaerythritol hexamethacrylate, glycerol dimethacrylate, hydroxypivaric acid neopentyl glycol dimethacrylate, dipenta-erythritol monohydroxypentamethacrylate, ditrimethylolpropane tetramethacrylate, pentaerythritol trimethacrylate, pentaerythritol tetramethacrylate, triglycerol dimeth-acrylate, trimethylolpropane trimethacrylate, tris(methacryloxyethyl) isocyanurate, allyl methacrylate, divinylbenzene, diallyl phthalate, diallyl terephthalate, diallyl isophthalate and diethylene glycol bisallylcarbonate.

The size of the polymer-coated pigment formed is dependent on one or more of the concentration of the reagents, the size of a particulate organic pigment, and the thickness of the metal oxide or metalloid oxide coating layer, for example. The particle size (cross-sectional dimension) of the polymer-coated pigment is in a range from about 1 nanometer (nm) to about 1,000 nm, or from about 1 nm to about 750 nm, or from about 1 nm to about 500 nm, or from about 1 nm to about 200 nm, or from about 1 nm to about 100 nm, or from about 1 nm to about 50 nm, or from about 2 nm to about 500 nm, or from about 2 nm to about 400 nm, or from about 2 nm to about 300 nm, or from about 2 nm to about 200 nm, or from about 2 nm to about 100 nm, or from about 2 nm to about 50 nm, or from about 5 nm to about 500 nm, or from about 5 nm to about 400 nm, or from about 5 nm to about 300 nm, or from about 5 nm to about 200 nm, or from about 5 nm to about 100 nm, or from about 5 nm to about 50 nm, or from about 10 nm to about 500 nm, or from about 10 nm to about 400 nm, or from about 10 nm to about 300 nm, or from about 10 nm to about 200 nm, or from about 10 nm to about 100 nm, or from about 10 nm to about 50 nm.

In some embodiments one or more durability agents may be incorporated either non-covalently or covalently into the polymer. The durability agents include, for example, a UV absorber, a light stabilizer (such as, for example, a hindered amine light stabilizer), an antioxidant, a free radical scavenger, a water resistance material, a humid fastness agent, or mixtures of two or more of the above. The amount of the durability agents in the polymer-coated pigment composition depends on one or more of the nature of the durability agent, the nature of the organic pigment, the nature of the ink composition, and the nature of the printing process utilizing the ink composition, for example. In some embodiments the amount (by weight percent) of each durability agent in the polymer is about 0.01 to about 20%, or about 0.05 to about 20%, or about 0.1 to about 20%, or about 0.5 to about 20%, or about 1 to about 20%, or about 2 to about 20%, or about 5 to about 20%, or about 10 to about 20%, or about 0.01 to about 15%, or about 0.05 to about 15%, or about 0.1 to about 15%, or about 0.5 to about 15%, or about 1 to about 15%, or about 2 to about 15%, or about 5 to about 15%, or about 10 to about 15%, or about 0.01 to about 10%, or about 0.05 to about 10%, or about 0.1 to about 10%, or about 0.5 to about 10%, or about 1 to about 10%, or about 2 to about 10%, or about 5 to about 10%, for example.

A UV absorber is any substance that one or both absorbs UV light and enhances the light fastness of the polymer-coated pigment composition. In some embodiments the UV absorber contains a UV blocking chromophore, which imparts light fastness to the polymer-coated pigment composition. The UV absorbers may be water-based or oil-based. Examples of UV absorbers that may be employed in the present embodiments include, by way of illustration and not limitation, benzophenones such as, for example, CHIMASSORB® 81 from Ciba Corporation (Suffolk Va.); benzotriazoles such as, for example, TINUVIN® 1130, TINUVIN® 171, TINUVIN® 384, TINUVIN® 928, and CIBAFAST H® LIQUID (all from Ciba); triazines such as, for example, TINUVIN® 400, TINUVIN® 405, TINUVIN® 479 and TINUVIN® 477 (all from Ciba); TINUVIN® 109, TINUVIN® 384-2, TINUVIN® 2140, TINUVIN® 5050, and TINUVIN® 5151 (all from Ciba); other UV absorbers from Ciba include, for example, TINUVIN® 328, TINUVIN® 384, TINUVIN® 900, TINUVIN® 928, TINUVIN® 1130, TINUVIN® 123, TINUVIN® 144, TINUVIN® 292, TINUVIN® 1405, TINUVIN® 1930; UV absorbers available from Sunko Ink Co., Ltd, include, for example, UV-1®, UV-2® and UV-4®; UV absorbers available from Adeka Argus Chemical Co. include, for example, LA-77® and LA-62®; UV absorbers available from Johuku Chemical Co. include, for example, JF-77®.

Examples of hindered amine light stabilizers, by way of illustration and not limitation, include TINUVIN® 292, TINUVIN® 123, TINUVIN® 144 and TINUVIN® 152 (all from Ciba Corporation). Examples of UV absorber/hindered amine light stabilizer blends, by way of illustration and not limitation, include TINUVIN® 5050, TINUVIN® 5060, and TINUVIN® 5151 (all from Ciba Corporation). Examples of antioxidants, by way of illustration and not limitation, include IRGANOX® 1010, IRGANOX® 1076, IRGANOX® 1330 and IRGANOX® 3114 (all from Ciba Corporation).

In some embodiments the polymer-coated pigment composition is prepared, for example, by emulsion polymerization, which produces uniformly sized, nanometer particles of polymer-coated organic pigment. A monomer composition comprising one or more monomers in a suitable liquid medium is subjected to agitation (e.g., one or more of mixing bar, rocking and shaking), gentle shearing (e.g., one or more of sonication and milling) or high shearing (e.g., one or more of ultrasonication and microfluidization). The amount of the monomer(s) and the conditions for forming the monomer emulsion depend on the nature of the polymerization and the nature of the monomers, for example. In some embodiments the temperature during the formation of the monomer emulsion is about 10° C. to about 100° C., or about 10° C. to about 50° C., or about 10° C. to about 40° C., or about 20° C. to about 100° C., or about 20° C. to about 50° C., or about 20° C. to about 40° C., for example. The time period is about 0.01 to about 5 hours or more, or about 0.1 to about 5 hours or more, or about 0.2 to about 5 hours or more, or about 0.01 to about 4 hours or more, or about 0.1 to about 4 hours or more, or about 0.2 to about 4 hours or more, or about 1 to about 5 hours, or about 1 to about 4 hours or more, or about 1 to about 3 hours or more, or about 2 to about 5 hours or more, for example. The nature of the liquid medium is dependent on the nature of the monomers and the nature of the polymerization, for example. The liquid medium may be, for example, an aqueous medium or an organic solvent medium, or a combination thereof.

The organic pigment with non-covalently attached metal oxide or metalloid oxide is combined with a suitable polymerization medium, which, by way of illustration and not limitation, may be an aqueous medium or an organic solvent medium, or a combination thereof. The polymerization medium may also contain a polymerization initiator, one or more durability agents and one or more surfactants to control the diameter of the polymer-coated pigment composition. The monomer composition in the liquid medium described above is combined with the polymerization medium. In some embodiments the monomer composition is added dropwise to the polymerization medium. Other modes of combining the monomer emulsion in the liquid medium with the polymerization medium may also be employed. Depending on the nature of the monomers, the monomers may self-polymerize, polymerize through a condensation reaction, polymerize through free radical addition polymerization by means of a thermal activated free radical initiator, or polymerize through cross-linking, for example.

The conditions for polymerization include, for example, a temperature of about 5° C. to about 150° C., or about 15° C. to about 125° C., or about 20° C. to about 120° C., or about 20° C. to about 100° C. The temperature may be constant during the polymerization or the temperature may be varied one or more times during the polymerization. The medium is incubated under conditions for forming the polymer-coated pigment composition. The incubation period may be about 1 minute to about 20 hours or more, or about 10 minutes to about 20 hours or more, or about 30 minutes to about 20 hours or more, or about 1 hour to about 20 hours or more, or about 1 hour to about 15 hours, or about 1 hour to about 10 hours, or about 1 hour to about 5 hours, for example. The pH of the reaction medium is in the range of about 0.3 to about 10, or about 2 to about 9, or about 5 to about 8, or about 5 to about 7, or about 6 to about 9, or about 7 to about 9, for example. The polymer-coated pigment composition is separated from the reaction mixture by, for example, filtration or centrifugation, and is purified by washing, for example.

In another approach for preparation of a polymer-coated pigment composition in accordance with the present embodiments, a polymer is prepared from appropriate monomers by any of the aforementioned polymerization techniques. An organic pigment with non-covalently attached metal oxide or metalloid oxide is added to a molten polymer (temperature of about 40° C. to about 200° C.) that is sprayed or dropwise added into a lower temperature liquid bath (temperature of about 0° C. to about 40° C.) in which the molten solution forms nanospheres and solidifies by freezing. The molten polymer and bath liquid are immiscible. The sprayed particles may optionally be solidified by exposure to a gas or gases (e.g. air or inert gas). Alternatively, an organic pigment with non-covalently attached metal oxide or metalloid oxide may be combined with a solid polymer in a suitable solvent. The coated organic pigment and polymer are selected to be immiscible in a liquid bath, while the solvent is selected to be miscible in both the organic pigment-polymer combination and the bath solution. The organic pigment-polymer combination is added dropwise to the agitated bath to form nanospheres. The solvent is drawn into the bath liquid sufficient to solidify the pigment-polymer spheres.

In one embodiment a polymer-coated pigment composition has as the organic pigment PY74, which has a silica layer non-covalently bound to the surface of the PY74 pigment. Attached to the silica is a polymer that comprises polymerized methyl methacrylate and methacrylic acid monomers. A benzophenone UV absorber (CHIMASSORB® 81 from Ciba Corporation) (2%) is distributed in the polymer. The cross-sectional diameter of the polymer-coated pigment composition is 200 nm. An ink composition is prepared, which comprises the polymer-coated pigment composition in an aqueous medium and further comprises one or more of a surfactant, a humectant, a sequestering agent, and a biocide, for example. The ink is used in an inkjet printer and is dispensed to the surface of paper.

In one embodiment a polymer-coated pigment composition has a cynanine (Cy7) as the organic pigment, which has an aluminum oxide layer non-covalently attached to the surface of the organic pigment. The polymer comprises polymerized styrene and vinyl benzoic acid monomers (2:1) and is covalently attached to the aluminum oxide layer. A benzotriazole UV absorber (TINUVIN® 1130 from Ciba Corporation) (4%) is covalently attached to the polymer. Also, in the polymer are TINUVIN®292 (as a free radical scavenger) (2%) and IRGANOX® 1010 (as an antioxidant) (2%) The cross-sectional diameter of the polymer-coated pigment composition is 225 nm. An ink composition is prepared, which comprises the polymer-coated pigment composition in an aqueous medium and further comprising one or more organic cosolvents. The ink is used in an inkjet printer and is dispensed to the surface of paper.

In one embodiment a polymer-coated pigment composition has a combination of organic pigments, namely, Pigment Red 122 and Pigment Yellow 74. The organic pigment combination is coated with silica, which is non-covalently attached to the surface of the organic pigment combination. The polymer that is attached to the silica comprises polymerized n-hexyl methacrylate monomer and methacrylic acid monomer (1:1). A triazine UV absorber (TINUVIN® 81 from Ciba Corporation) (4%) is non-covalently distributed in the polymer. The cross-sectional diameter of the polymer-coated pigment composition is 250 nm. An ink composition is prepared, which comprises the polymer-coated pigment composition in an aqueous medium and further comprises one or more organic cosolvents. The ink is used in an inkjet printer and is dispensed to the surface of paper.

In one embodiment a polymer-coated pigment composition has Pigment Yellow 128 as the organic pigment, which has a zinc oxide coating non-covalently attached to the surface of the organic pigment. The polymer attached to the zinc oxide comprises polymerized methyl methacrylate monomer, hexyl acrylate monomer, mono-methacryloyloxyethyl succinate monomer and ethylene glycol dimethacrylate monomer. The ratio of monomers to one another (by weight) is 120/25/2.5/1. A triazine UV absorber (TINUVIN® 479 from Ciba Corporation) (4%) is non-covalently distributed in the polymer, which also comprises 3% IRGANOX® 1010 antioxidant (Ciba Corporation) and 4% TINUVIN® 292 hindered amine light stabilizer (Ciba Corporation). The cross-sectional diameter of the polymer-coated pigment composition is 250 nm. An ink composition is prepared, which comprises the polymer-coated pigment composition in an aqueous medium and further comprising one or more organic cosolvents. The ink is used in an inkjet printer and is dispensed to the surface of paper.

In another embodiment, methyl methacrylate is replaced in the above Pigment Yellow 128 embodiment by styrene under similar conditions. In another embodiment, the anti-oxidant IRGANOX® 1010 in the above Pigment Yellow 128 embodiment is replaced to 2,6-di-t-butylphenol and the hindered amine light stabilizer TINUVIN® 292 is replaced by TINUVIN® 152.

The present compositions and methods may reduce or avoid problems with surface incompatibilities among organic pigments of different chemical composition. The difficulties that are encountered due to differences in surface chemistries and polarities of various pigments may be substantially overcome. In accordance with present embodiments the surface of different pigments is treated to introduce a non-covalently attached coating layer that serves to provide more uniformity for subsequent attachment of a polymer. Polymer-coated pigment compositions of the present embodiments can be prepared where the polymer is substantially the same across a wide variety of pigments that are otherwise difficult to formulate into ink compositions.

The polymer-coated pigment compositions of the present embodiments are stable in an ink environment or an ink vehicle, which may be an aqueous medium or an oil-based medium. For example, the polymer-coated pigment compositions of the present embodiments find use in many different water-based systems such as coatings and inks The polymer-coated pigment compositions of the present embodiments may be used in most ink media known in the art. The ink compositions comprising the present polymer-coated pigment compositions provide a variety of colors depending on the nature of the pigment of the polymer-coated pigment compositions.

In some embodiments, the polymer-coated pigment composition is employed in an aqueous medium, which is a water-based system that may or may not contain other solvents such as organic solvents that are polar and compatible with water. The amount (by weight percent) of the organic solvent may be between about 0.01 and about 20%, or between about 0.01 and about 10% or between about 0.01 and about 5%, or about 0.1 and about 20%, or between about 0.1 and about 10% or between about 0.1 and about 5%, or about 1 and about 20%, or between about 1 and about 10% or between about 1 and about 5%. Examples of suitable classes of organic solvents compatible with water include, but are not limited to, aliphatic alcohols, aromatic alcohols, diols, caprolactams, lactones, formamides, acetamides, long chain alcohols, and mixtures thereof. Examples of suitable organic solvents include, but are not limited to, primary aliphatic alcohols of 30 carbons or fewer, primary aromatic alcohols of 30 carbons or fewer, secondary aliphatic alcohols of 30 carbons or fewer, secondary aromatic alcohols of 30 carbons or fewer, 1,2-alcohols of 30 carbons or fewer, 1,3-alcohols of 30 carbons or fewer, 1,5-alcohols of 30 carbons or fewer, N-alkyl caprolactams, unsubstituted caprolactams, substituted formamides, unsubstituted formamides, substituted acetamides, unsubstituted acetamides, and mixtures thereof. Some specific suitable examples of organic solvents include, but are not limited to, 1,5-pentanediol, 2-pyrrolidone, 1,2-hexanediol, 2-ethyl-2-hydroxymethyl-1,3-propanediol, diethylene glycol, 3-methoxybutanol, 1,3-dimethyl-2-imidazolidinone, and mixtures thereof.

The aqueous medium may also optionally include one or more water-soluble surfactants in amounts ranging between about 0 and 5%, or between about 0.1 and about 5%, or about 0.5 and about 5%, or about 1 to about 5%. Examples of suitable surfactants include, by way of illustration and not limitation, fluorosurfactants, alkyl polyethylene oxides, non-ionic surfactants, amphoteric surfactants, ionic surfactants, and mixtures of two or more of the above. The balance of the aqueous medium is usually water. In an embodiment the aqueous medium comprises a mixture of water, glycol and a polymer-coated pigment composition, for example, for most everyday printing applications.

In other embodiments, the ink composition comprising a polymer-coated pigment composition in accordance with the present embodiments is a solvent-based ink comprising one or more volatile organic solvents. The organic solvent may be polar or non-polar. Polar organic solvents include, for example, alcohols, ethers, amides, esters and amines such as those listed above. Non-polar organic solvents include, for example, hydrocarbons, which may be branched, unbranched or cyclic. In some embodiments the hydrocarbon may have about 10 to about 20 carbon atoms, for example. The hydrocarbon may be an alkane, an isoalkane, a tertiary alkane, a cyclic or multicyclic alkane or an aromatic compound, for example, or mixtures of two or more of the above. In some embodiments the hydrocarbon is an isoparaffinic hydrocarbon solvent. In some embodiments the hydrocarbon may be isoparaffinic. The organic solvent-based inks find use in printing of vinyl substrates (e.g., billboards and banners), graphic arts, printing of packaging materials, liquid electrophotography, and electrophoretic displays, for example.

The amount of the polymer-coated pigment composition in the ink medium depends on one or more of the nature of the pigment, the nature of the polymer, the nature of the printing process, the nature of the ink medium, the desired optical density, and the color and tintorial strength of the pigments, for example. The amount (by weight percent) of the polymer-coated pigment composition in the ink medium may be about 0.5 to about 20%, or about 0.5 to about 15%, or about 0.5 to about 10%, or about 0.5 to about 5%, or about 0.5 to about 3%, or about 1 to about 20%, or about 1 to about 15%, or about 1 to about 10%, or about 1 to about 5%, or about 1 to about 3%, or about 5 to about 20%, or about 5 to about 15%, or about 5 to about 10%, for example.

### DEFINITIONS

The following provides definitions for terms and phrases used above, which were not previously defined.

The phrase “at least” as used herein means that the number of specified items may be equal to or greater than the number recited. The phrase “about” as used herein means that the number recited may differ by plus or minus 10%; for example, “about 5” means a range of 4.5 to 5.5. The term “between” when used in conjunction with two numbers such as, for example, “between about 2 and about 50” includes both of the numbers recited. Moreover, examples herein are intended to be illustrative only and are presented for discussion purposes and not by way of limitation.

The term “substituted” means that a hydrogen atom of a compound or moiety is replaced by another atom such as a carbon atom or a heteroatom, which is part of a group referred to as a substituent. Substituents include, for example, alkyl, alkoxy, aryl, aryloxy, alkenyl, alkenoxy, alkynyl, alkynoxy, thioalkyl, thioalkenyl, thioalkynyl, and thioaryl.

The term “heteroatom” as used herein means nitrogen, oxygen, phosphorus or sulfur. The terms “halo” and “halogen” mean a fluoro, chloro, bromo, or iodo substituent. The term “cyclic” means having an alicyclic or aromatic ring structure, which may or may not be substituted, and may or may not include one or more heteroatoms. Cyclic structures include monocyclic structures, bicyclic structures, and polycyclic structures. The term “alicyclic” is used to refer to an aliphatic cyclic moiety, as opposed to an aromatic cyclic moiety.

The term “alkoxy” as used herein means an alkyl group bound to another chemical structure such as, for example, a carbon atom or a silicon atom, through a single, terminal ether linkage, wherein the alkyl group has 1 to about 10 carbon atoms, or 1 to about 9 carbon atoms, or 1 to about 8 carbon atoms, or 1 to about 7 carbon atoms, or 1 to about 6 carbon atoms, or 1 to about 5 carbon atoms, or 1 to about 4 carbon atoms, or 1 to about 3 carbon atoms, or 1 to 2 carbon atoms, or 2 to about 10 carbon atoms, or 2 to about 5 carbon atoms, or 2 to about 4 carbon atoms, or 2 to 3 carbon atoms, for example. As used herein, the term “alkoxy” includes, for example, methoxy, ethoxy, n-propoxy, isopropoxy, and t-butoxy.

The term “aromatic” includes monocyclic rings, bicyclic ring systems, and polycyclic ring systems, in which the monocyclic ring, or at least a portion of the bicyclic ring system or polycyclic ring system, exhibit aromatic characteristics, for example, π-conjugation. The monocyclic rings, bicyclic ring systems, and polycyclic ring systems of the aromatic group may include one or both of carbocyclic rings and heterocyclic rings. The term “carbocyclic ring” denotes a ring in which each ring atom is carbon. The term “heterocyclic ring” denotes a ring in which at least one ring atom is not carbon and comprises 1 to 4 heteroatoms.

### EXAMPLES

Unless otherwise indicated, materials in the experiments below may be purchased from Aldrich Chemical Company, St. Louis Mo. Parts and percentages herein are by weight unless indicated otherwise.

### Example 1

### Dispersion of PY74

The yellow pigment PY74 from Heubach (20 g) was mixed in water (113 ml) containing sodium dodecyl sulfate (4 g). This mixture was stirred at ambient temperature for 24 hours and then the mixture was sonicated using a Branson ultrasonicator (Branson Digital Sonifier Model 450, Branson Ultrasonics Corporation, Danbury Conn.) for 1 hour at 90% amplitude. This solution was further microfluidized at 90 psi with three passes using a 197 micron chamber. This yielded a stable dispersion containing 14.3% (by weight) solid particles having a particle size of 200 nm.

### Example 2

### Metal Oxide Coating

Pigment dispersion from Example 1 (20 g) is mixed with tetraethyl orthosilicate (0.45 g) and stirred vigorously. Then, ammonium hydroxide is added to bring the pH of the solution to 9.5. This mixture is brought to 50° C. for 24 hours to obtain a silica coated PY74 pigment dispersion wherein the silica is non-covalently attached to the pigment surface.

### Example 3

### Polymer Attachment to Silica Coating

The silica coated PY74 pigment dispersion from Example 2 above (83.5 g) is mixed with an emulsion prepared by mixing styrene (5.4 g), butyl methacrylate (6 g), methacrylic acid (0.6 g), hexadecane (0.36 g) and azobisisobutyronitrile (0.36 g) in water (8 g) containing sodium dodecylsulfate (0.36 g). The mixture is shaken well and then is subjected to microfluidization at 90 psi with three passes. The mixture is heated to 80° C. for 15 hours to obtain a polymer matrix non-covalently attached to a surface of the silica coating on the surface of the organic pigment.

### Example 4

### Ink Composition

The polymer-silica coated PY74 pigment dispersion from Example 3 above is used to prepare an ink composition for use in an inkjet printer. An aqueous medium is prepared containing 2% 1,2-hexanediol and 1% fluorosurfactant (ZONYL® fluorosurfactant from E.I. du Pont de Nemours and Co., Wilmington Del.). To the aqueous medium is added the polymer-coated pigment composition from Example 3 so that the final concentration of the pigment in the aqueous medium is 2%. A print cartridge of an inkjet printer is filled with the ink medium from above and the ink medium is dispensed through the nozzles of the inkjet printer.

Although the foregoing invention has been described in some detail by way of illustration and example for purposes of clarity of understanding, it will be readily apparent to those of ordinary skill in the art in light of the teachings of this invention that certain changes and modifications may be made thereto without departing from the spirit or scope of the appended claims. Furthermore, the foregoing description, for purposes of explanation, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description; they are not intended to be exhaustive or to limit the invention to the precise forms disclosed. Many modifications and variations are possible in view of the above teachings. The embodiments were chosen and described in order to explain the principles of the invention and its practical applications and to thereby enable others skilled in the art to utilize the invention.

What is claimed is:

1. A polymer-coated pigment composition comprising:
(a) at least one organic pigment; and
(b) a coating layer non-covalently attached to an outer surface of the organic pigment, wherein the coating layer comprises at least one metal oxide or metalloid oxide and a polymer attached to an outer surface of the metal oxide or the metalloid oxide.

2. The polymer-coated pigment composition according to claim 1, wherein the metal oxide or the metalloid oxide is selected from the group consisting of silicon oxide, aluminum oxide, zinc oxide, germanium oxide, tin oxide, indium oxide, magnesium oxide, titanium oxide, manganese oxide, zirconium oxide, niobium oxide, yttrium oxide and scandium oxide and combinations thereof and derivatives thereof.

3. The polymer-coated pigment composition according to claim 1, wherein the pigment composition comprises two or more organic pigments.

4. The polymer-coated pigment composition according to claim 1, wherein the organic pigment is selected from the group consisting of perylenes, phthalo green, phthalo blue, nitroso pigments, monoazo pigments, diazo pigments, diazo condensation pigments, basic dye pigments, alkali blue pigments, blue lake pigments, phloxin pigments, quinacridone pigments, lake pigments of acid yellow 1 and 3, carbazole dioxazine violet pigments, alizarine lake pigments, vat pigments, phthaloxy amine pigments, carmine lake pigments, tetrachloroisoindolinone pigments, anthraquinones, phthalocyanine blues, phthalocyanine greens, pyranthrones, heterocyclic yellows, bisindolidione pigments, (thio)indigoid pigments, and mixtures thereof.

5. The polymer-coated pigment composition according to claim 1, wherein the organic pigment is Pigment Yellow 74 and the coating layer is silica.

6. The polymer-coated pigment composition according to claim 1, wherein the polymer is latex.

7. The polymer-coated pigment composition according to claim 1, wherein the coating layer has a thickness of about one to about ten nanometers.

8. An ink composition comprising an ink vehicle and the polymer-coated pigment composition according to claim 1.

9. A method of enhancing dispersibility of an organic pigment, the method comprising:
(a) coating a surface of the organic pigment by non-covalently attaching to the surface a metal oxide or a metalloid oxide or a combination thereof; and
(b) attaching a polymer to an outer surface of the metal oxide or the metalloid oxide or the combination.

10. The method according to claim 9, wherein (a) coating a surface comprises contacting a surface of the pigment with a metal oxide or a metal oxide precursor or a metalloid oxide or a metalloid oxide precursor under conditions wherein the metal oxide or the metalloid oxide becomes non-covalently attached to the surface of the pigment or the metal oxide precursor or the metalloid oxide precursor forms the metal oxide or the metalloid oxide non-covalently attached to the surface of the pigment.

11. The method according to claim 9, wherein (a) coating a surface comprises a sol-gel process.

12. The method according to claim 9, wherein (b) attaching a polymer comprises contacting the surface of the coated organic pigment with at least one monomer under conditions for conducting a polymerization reaction to form a polymer attached to an outer surface of the metal oxide or the metalloid oxide.

13. The method according to claim 9, wherein the metal oxide or the metalloid oxide is selected from the group consisting of silicon oxide, aluminum oxide, zinc oxide, germanium oxide, tin oxide, indium oxide, magnesium oxide, titanium oxide, manganese oxide, zirconium oxide, niobium oxide, yttrium oxide and scandium oxide and combinations thereof and derivatives thereof.

14. The method according to claim 9, wherein the pigment composition comprises two or more organic pigments.

15. The method according to claim 9, wherein the organic pigment is Pigment Yellow 74 and the coating layer is silica.

16. The method according to claim 9, wherein the polymer is latex.

17. An ink composition comprising:
(a) an ink vehicle, and
(b) a polymer-coated pigment composition comprising (i) at least one organic pigment; (ii) a coating layer comprising silicon oxide non-covalently attached to an outer surface of the organic pigment, and (iii) a latex polymer attached to an outer surface of the silicon oxide.

18. The ink composition according to claim 17, wherein the polymer-coated pigment composition comprises two or more organic pigments.

19. The ink composition according to claim 17, wherein the organic pigment is selected from the group consisting of perylenes, phthalo green, phthalo blue, nitroso pigments, monoazo pigments, diazo pigments, diazo condensation pigments, basic dye pigments, alkali blue pigments, blue lake pigments, phloxin pigments, quinacridone pigments, lake pigments of acid yellow 1 and 3, carbazole dioxazine violet pigments, alizarine lake pigments, vat pigments, phthaloxy amine pigments, carmine lake pigments, tetrachloroisoindolinone pigments, anthraquinones, phthalocyanine blues, phthalocyanine greens, pyranthrones, heterocyclic yellows, bisindolidione pigments, (thio)indigoid pigments, and mixtures thereof.

20. The ink composition according to claim 17, wherein the silicon oxide layer has a thickness of about one to about ten nanometers.
